(19) United States
(12) Patent Application Publication
(10) Pub. No.: US 2024/0423185 A1
(43) Pub. Date: Dec. 26, 2024

(54) Fishing Rod and Reel Cleaning Device

(71) Applicant: Samuel Tyler, Myrtle Beach, SC (US)

(72) Inventor: Samuel Tyler, Myrtle Beach, SC (US)

(21) Appl. No.: 18/503,274

(22) Filed: Nov. 7, 2023

Related U.S. Application Data
(60) Provisional application No. 63/522,509, filed on Jun. 22, 2023.

(51) Int. Cl. A01K 97/08; B08B 3/02

(52) U.S. Cl. CPC A01K 97/08; B08B 3/02

(57) ABSTRACT

A fishing rod and reel cleaning device is provided. The device allows a user to quickly and easily clean a fishing rod by inserting the rod into the interior space of the device wherein the rod is cleaned by a plurality of nozzles that spray liquid from a reservoir or from a water line. In another embodiment, the device is comprised of an exterior hose that can be used to spray liquid from a reservoir or from a water line onto a fishing rod.

### CROSS-REFERENCE TO RELATED APPLICATION

The present application claims priority to, and the benefit of, U.S. Provisional Application No. 63/522,509, which was filed on Jun. 22, 2023, and is incorporated herein by reference in its entirety.

### FIELD OF THE INVENTION

The present invention relates generally to the field of fishing. More specifically, the present invention relates to a fishing rod and reel cleaning device that can be used to easily clean a fishing rod and/or reel without significant physical exertion. Accordingly, the present disclosure makes specific reference thereto. Nonetheless, it is to be appreciated that aspects of the present invention are also equally applicable to other like applications, devices, and methods of manufacture.

### BACKGROUND

Salt water exposure can significantly damage fishing rods due to the corrosive nature of the water. When fishing in saltwater environments, the combination of salt and moisture can cause rust, corrosion, and deterioration of the rod's materials over time. As a result, anglers must take precautionary measures to preserve the integrity and longevity of their fishing rods.

One crucial step in maintaining fishing rods after saltwater fishing is a thorough cleaning. Cleaning the rods helps remove any salt residue, sand, and other contaminants that might have adhered to the surface during the fishing trip. Neglecting this post-fishing cleaning process can lead to accelerated wear and tear, diminishing the rod's performance and overall lifespan.

Unfortunately, cleaning fishing rods after saltwater fishing is often perceived as a long and tedious task by many anglers. This perception may discourage some from properly maintaining their equipment, inadvertently leading to more frequent rod replacements and increased expenses over time.

Therefore, there exists a long-felt need in the art for a fishing rod cleaning device. More specifically, there exists a long-felt need in the art for a fishing rod cleaning device that can be used to clean a fishing rod after salt water exposure. In addition, there exists a long-felt need in the art for a fishing rod cleaning device that can be used to clean a fishing rod in a manner that is easy and not labor-intensive.

The subject matter disclosed and claimed herein, in one embodiment thereof, comprises a fishing rod cleaning device. The device allows a user to quickly and easily clean a fishing rod. In one embodiment, a user can insert the rod into the interior space of the device wherein the rod is cleaned by a plurality of nozzles that spray liquid from a reservoir or from a water line. In another embodiment, the device is comprised of an exterior hose that can be used to spray liquid from a reservoir or from a water line onto a fishing rod.

In this manner, the fishing rod cleaning device of the present invention accomplishes all the forgoing objectives and provides a device for cleaning a fishing rod. The device can be used to clean a fishing rod after salt water exposure (or other use). Further, the device accomplishes this in a manner that is easy and not labor-intensive.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing rod and reel cleaning device. The device allows a user to quickly and easily clean a fishing rod and/or reel. In one embodiment, a user can insert the rod into the interior space of the device wherein the rod is cleaned by a plurality of nozzles or via a handheld hose.

In one embodiment, the body is comprised of at least one opening surrounded by a plurality of bristles. The bristles allow a fishing rod to exit the interior space of the body during use, while also preventing water from spraying out of the interior space while simultaneously cleaning water from the rod once the rod is removed from the interior space from the opening. To provide access to the interior space, the body may be comprised of at least one lid.

The interior space is comprised of at least one reservoir which may be filled with any water, soap, or cleaning solution known in the art. The reservoir is in fluid communication with at least one nozzle positioned on at least one interior frame. The nozzle is preferably adjustable in position to be optimally pointed at a fishing rod within the interior space. To secure a fishing rod within the interior space during cleaning, the frame may be comprised of at least one fastener that receives the rod. During use, a user can use at least one actuation mechanism to activate a pump which pumps liquid from the reservoir to and out from the nozzles. In another embodiment, the device is comprised of at least one hose on the exterior of the body in fluid communication with the reservoir. In this manner, a nozzle of the hose can be used to spray liquid from the reservoir onto a rod outside of the body. In one embodiment, continuous water can be supplied to the reservoir via at least one male or female hose connection of any type known in the art.

The present invention is also comprised of a method of using the device. First, a device is provided comprised of a body having at least one pump, at least one actuation mechanism, at least one nozzle, and at least one fastener positioned in the interior space of the body. Then, a user can secure a fishing rod to the fastener by opening a lid of a body or by placing the rod into the body via at least one opening. Then, a user can use the actuation mechanism to power the pump such that liquid is pumped from the reservoir, and/or an exterior water source via a hose connection, to at least one nozzle which sprays the liquid on the fishing rod to clean the rod. Finally, the rod can be removed from the interior space and fastener and secured to a fastener on an exterior of the body to dry.

The present invention is also comprised of a second method of using the device. First, a device is provided comprised of a body having at least one pump, at least one actuation mechanism, and at least one hose comprised of at least one nozzle. Then, a user can use the actuation mechanism to power the pump such that liquid is pumped from the reservoir, and/or an exterior water source via a hose connection, to the hose and nozzle which then sprays the liquid on the fishing rod to clean the rod. Finally, the rod can be removed from the interior space and secured to a fastener on an exterior of the body to dry.

Accordingly, the fishing rod cleaning device of the present invention is particularly advantageous as it provides a device for cleaning a fishing rod. The device can be used to clean a fishing rod after salt water exposure (or other use). Further, the device accomplishes this in a manner that is easy and not labor-intensive. In this manner, the fishing rod cleaning device overcomes the limitations of existing cleaning fishing rods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fishing rod cleaning device of the present invention in accordance with the disclosed architecture;

FIG. 2 illustrates a top perspective view of one potential embodiment of a fishing rod cleaning device of the present invention while the lid is open in accordance with the disclosed architecture;

FIG. 3 illustrates a front view of one potential embodiment of a fishing rod cleaning device of the present invention in accordance with the disclosed architecture;

FIG. 4 illustrates a rear view of one potential embodiment of a fishing rod cleaning device of the present invention in accordance with the disclosed architecture;

FIG. 5 illustrates a flowchart of a method of using one potential embodiment of a fishing rod cleaning device of the present invention in accordance with the disclosed architecture; and

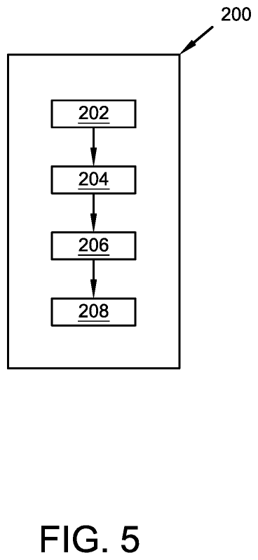

FIG. 6 illustrates a flowchart of a method of using one potential embodiment of a fishing rod cleaning device of the present invention in accordance with the disclosed architecture.

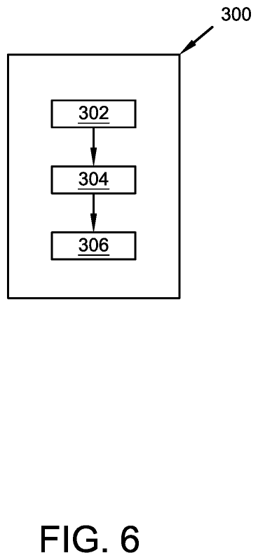

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fishing rod cleaning device. More specifically, there exists a long-felt need in the art for a fishing rod cleaning device that can be used to clean a fishing rod after salt water exposure. In addition, there exists a long-felt need in the art for a fishing rod cleaning device that can be used to clean a fishing rod in a manner that is easy and not labor-intensive.

The present invention, in one exemplary embodiment, is comprised of a fishing rod cleaning device. The device allows a user to quickly and easily clean a fishing rod. In one embodiment, a user can insert the rod into the interior space of the device wherein the rod is cleaned by a plurality of nozzles or via a handheld hose. In this embodiment, the body is comprised of at least one opening surrounded by a plurality of bristles. The bristles allow a fishing rod to exit the interior space of the body during use, while also preventing water from spraying out of the interior space while simultaneously cleaning water from the rod once the rod is removed from the interior space from the opening. To provide access to the interior space, the body may be comprised of at least one lid.

The interior space is comprised of at least one reservoir which may be filled with any water, soap, or cleaning solution known in the art. The reservoir is in fluid communication with at least one nozzle positioned on at least one interior frame. The nozzle is preferably adjustable in position to be optimally pointed at a fishing rod within the interior space.

To secure a fishing rod within the interior space during cleaning, the frame may be comprised of at least one fastener that receives the rod. During use, a user can use at least one actuation mechanism to activate a pump, which pumps liquid from the reservoir to and out from the nozzles. In another embodiment, the device is comprised of at least one hose on the exterior of the body in fluid communication with the reservoir that can be used to spray liquid from the reservoir onto a rod outside of the body. In one embodiment, continuous water can be supplied to the reservoir via at least one male or female hose connection of any type known in the art.

The present invention is also comprised of a method of using the device. First, a device is provided comprised of a body having at least one pump, at least one actuation mechanism, at least one nozzle, and at least one fastener positioned in the interior space of the body. Then, a user can secure a fishing rod to the fastener by opening a lid of a body or by placing the rod into the body via at least one opening. Then, a user can use the actuation mechanism to power the pump such that liquid is pumped from the reservoir, and/or an exterior water source via a hose connection, to at least one nozzle which sprays the liquid on the fishing rod to clean the rod. Finally, the rod can be removed from the interior space and fastener and secured to a fastener on an exterior of the body to dry.

The present invention is also comprised of a second method of using the device. First, a device is provided comprised of a body having at least one pump, at least one actuation mechanism, and at least one hose comprised of at least one nozzle. Then, a user can use the actuation mechanism to power the pump such that liquid is pumped from the reservoir, and/or an exterior water source via a hose connection, to the hose and nozzle which then sprays the liquid on the fishing rod to clean the rod. Finally, the rod can be removed from the interior space and secured to a fastener on an exterior of the body to dry.

Accordingly, the fishing rod cleaning device of the present invention is particularly advantageous as it provides a device for cleaning a fishing rod. The device can be used to clean a fishing rod after salt water exposure (or other use). Further, the device accomplishes this in a manner that is easy and not labor-intensive. In this manner, the fishing rod cleaning device overcomes the limitations of existing cleaning fishing rods known in the art.

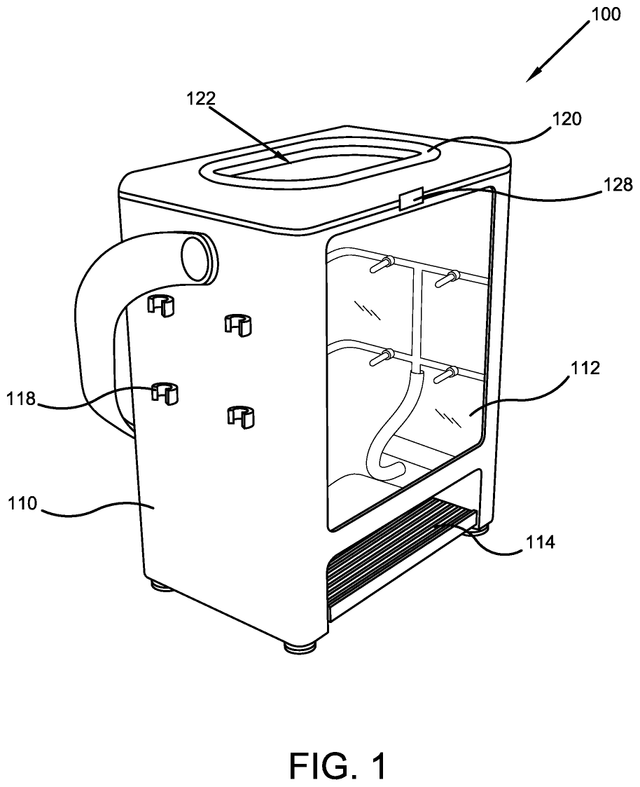

Referring initially to the drawings, FIG. 1 illustrates a perspective view of one potential embodiment of a fishing rod cleaning device 100 of the present invention in accordance with the disclosed architecture. The device 100 allows a user to quickly and easily clean a fishing rod 10. More specifically, a user can insert the rod 10 into the interior space 130 of the device 100 wherein the rod 10 is cleaned by a plurality of nozzles 138 or via a handheld hose 150.

The body 110 of the device 100 is preferably square in shape, but may be any shape and size known in the art that allows the device 100 to be portable, stationary, etc. The body 110 is comprised of at least one foot 111 that stabilizes the body 110 during use. In one embodiment, the foot 111 may be a wheel of any type known in the art.

In one embodiment, the body 110 is comprised of at least one opening 120. The opening 120 is surrounded by a plurality of bristles 122. The bristles 122 may be any type of natural or artificial bristle type 122 known in the art. The bristles 122 allow a fishing rod 10 to exit the interior space 130 of the body 110 during use, while also preventing water from spraying out of the interior space 130 while simultaneously cleaning water from the rod 10 once the rod 10 is removed from the interior space 130 from the opening 120.

To provide access to the interior space 130, the body 110 may be comprised of at least one lid 124. The lid 124 attaches to the body 110 via at least one hinge 126 of any type known in the art. To secure the lid 124 to the body 110, the lid 124 and/or body 110 may be comprised of at least one lock 128. The lock 128 may be of any type known in the art.

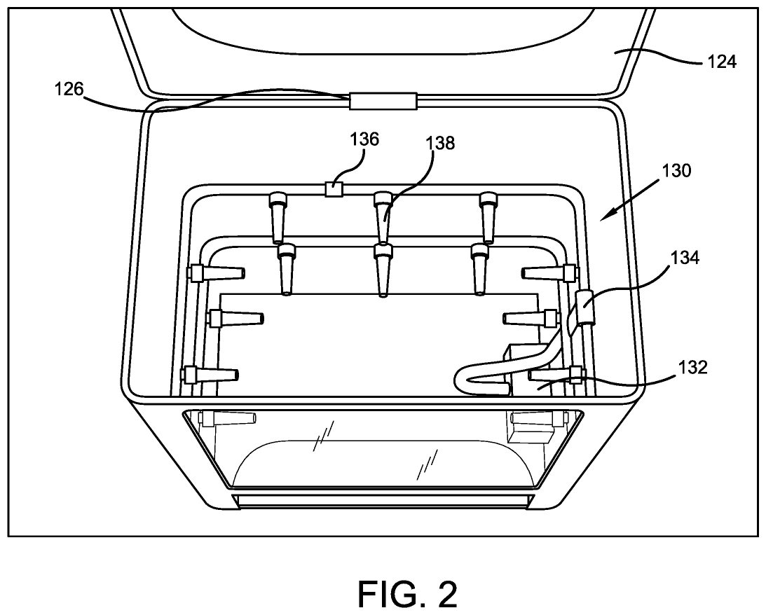

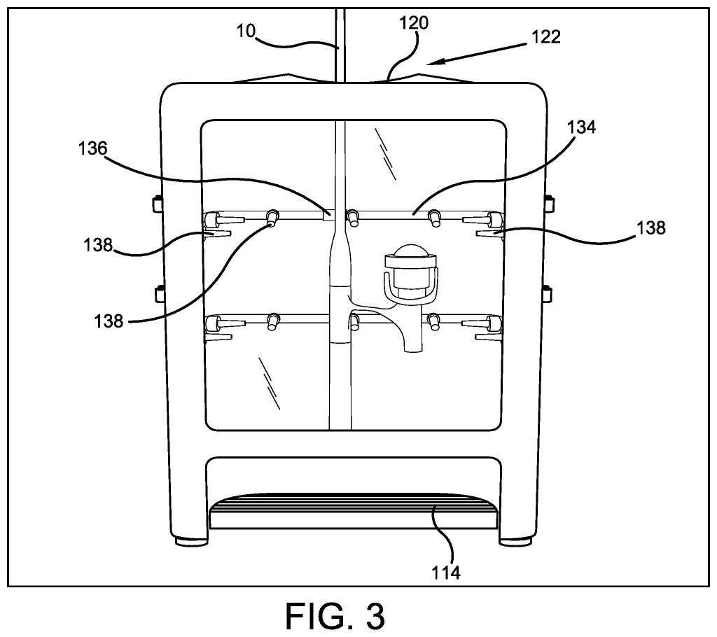

The interior space 130 is comprised of at least one reservoir 132, as best seen in FIG. 2. The reservoir 132 may be filled with any water, soap, or cleaning solution known in the art. The reservoir 132 is in fluid communication with at least nozzle 138 positioned on at least one interior frame 134. The nozzle 138 is preferably adjustable in position to be optimally pointed at a fishing rod 10 within the interior space 130. To secure a fishing rod 10 within the interior space 130 during cleaning, the frame 134 may be comprised of at least one fastener 136 that receives the rod 10, as seen in FIG. 3. The fastener 136 may be any type known in the art such as but not limited to a clip, a clamp, etc.

During use, a user can use at least one actuation mechanism 114 to activate a pump 170 which pumps liquid from the reservoir 132 to and out from the nozzles 138. The actuation mechanism 114 is preferably a depressible foot pedal. However, in another embodiment the mechanism 114 may be a button, a lever, etc. In this manner, liquid from the nozzles 138 cleans the fishing rod 10.

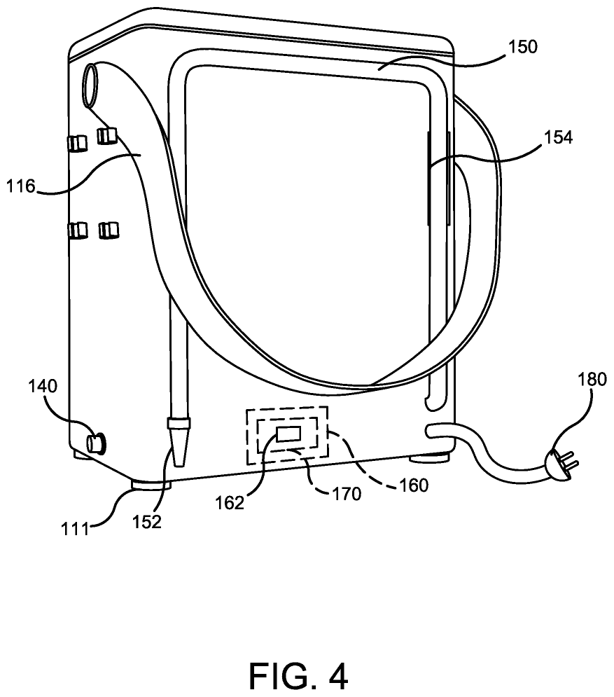

In another embodiment, the device 100 is comprised of at least one hose 150 on the exterior of the body 110, as seen in FIG. 4. In this embodiment, the hose 150 is in fluid communication with the reservoir 132. In this manner, a nozzle 152 of the hose 150 can be used to spray liquid from the reservoir 132 onto a rod 10 outside of the body 110. When not in use, the hose 150 may be secured to the body 110 via at least one fastener 154 such as but not limited to a clip.

In one embodiment, continuous water can be supplied to the reservoir 132 via at least one male or female hose connection 140 of any type known in the art. The exterior of the body 110 may also be comprised of at least one fastener 118 such as but not limited to a clip, a clamp, etc. that receives a rod 10 and allows the rod 10 to dry outside of the body 110. The body 110 may also be comprised of at least one strap 116, handle, etc. that allows the device 100 to be easily carried. In one embodiment, cleaning of the rod 10 in the interior space 130 can be observed view at least one viewing window 112 that is preferably transparent.

The pump 170 is powered by at least one battery 160. The battery 160 may receive power via at least one power cord 180 of any type known in the art. In another embodiment, the battery 160 is powered by at least one charging port 162 of any type known in the art.

The present invention is also comprised of a method of using 200 the device 100. First, a device 100 is provided comprised of a body 110 having at least one pump 170, at least one actuation mechanism 114, at least one nozzle 138, and at least one fastener 136 positioned in the interior space 130 of the body [Step 202]. Then, a user can secure a fishing rod 10 to the fastener 136 via opening a lid 124 of a body 110 or by placing the rod 10 into the body 110 via at least one opening 132 [Step 204]. Then, a user can use the actuation mechanism 114 to power the pump 170 such that liquid is pumped from the reservoir 132, and/or an exterior water source via a hose connection 140, to at least one nozzle 138 which sprays the liquid on the fishing rod 10 to clean the rod 10 [Step 206]. Finally, the rod 10 can be removed from the interior space 130 and fastener 136 and secured to a fastener 118 on an exterior of the body 110 to dry [Step 208].

The present invention is also comprised of a method of using 300 the device 100. First, a device 100 is provided comprised of a body 110 having at least one pump 170, at least one actuation mechanism 114, and at least one hose 150 comprised of at least one nozzle 152 [Step 302]. Then, a user can use the actuation mechanism 114 to power the pump 170 such that liquid is pumped from the reservoir 132, and/or an exterior water source via a hose connection 140, to the hose 150 and nozzle 152 which then sprays the liquid on the fishing rod 10 to clean the rod 10 [Step 304]. Finally, the rod 10 can be removed from the interior space 130 and secured to a fastener 118 on an exterior of the body 110 to dry [Step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing rod cleaning device” and “device” are interchangeable and refer to the fishing rod cleaning device 100 of the present invention.

Notwithstanding the forgoing, the fishing rod cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fishing rod cleaning device 100 as shown in the FIGS. are for illustrative purposes only, and that many other sizes and shapes of the fishing rod cleaning device 100 are well within the scope of the present disclosure. Although the dimensions of the fishing rod cleaning device 100 are important design parameters for user convenience, the fishing rod cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing rod and reel cleaning device comprising:
a body comprised of an interior space;
a nozzle positioned within the interior space;
a first fastener positioned with the interior space;
a pump;
a reservoir in fluid communication with the nozzle; and
an actuation mechanism which activates the pump.

2. The fishing rod and reel cleaning device of claim 1, wherein the body is comprised of an opening.

3. The fishing rod and reel cleaning device of claim 1, wherein the first fastener is positioned on an interior frame.

4. The fishing rod and reel cleaning device of claim 1, wherein the first fastener is comprised of a clip.

5. The fishing rod and reel cleaning device of claim 1, wherein the nozzle is comprised of an adjustable nozzle.

6. The fishing rod and reel cleaning device of claim 1, wherein the actuation mechanism is comprised of a foot pedal.

7. The fishing rod and reel cleaning device of claim 1, wherein the actuation mechanism is comprised of a button.

8. The fishing rod and reel cleaning device of claim 1, wherein the body is comprised of a transparent viewing window.

9. A fishing rod and reel cleaning device comprising:
a body comprised of an interior space;
a nozzle positioned within the interior space;
a first fastener positioned with the interior space;
a pump;
a reservoir in fluid communication with the nozzle;
an actuation mechanism which activates the pump;
a hose positioned on an exterior of the body; and
a second fastener positioned on an exterior of the body.

10. The fishing rod and reel cleaning device of claim 9 further comprised of a strap or a handle.

11. The fishing rod and reel cleaning device of claim 9, wherein the body is comprised of an opening.

12. The fishing rod and reel cleaning device of claim 11, wherein the opening is comprised of a bristle.

13. The fishing rod and reel cleaning device of claim 9, wherein the body is comprised of a lid.

14. The fishing rod and reel cleaning device of claim 9 further comprised of a lock.

15. The fishing rod and reel cleaning device of claim 9, wherein the exterior of the body is comprised of a third fastener.

16. The fishing rod and reel cleaning device of claim 15, wherein the third fastener is comprised of a clip.

17. The fishing rod and reel cleaning device of claim 15, wherein the third fastener receives the hose.

18. The fishing rod and reel cleaning device of claim 9 further comprised of a battery.

19. A method of using a fishing rod and reel cleaning device, the method comprising the following steps:
providing a fishing rod and reel cleaning device comprised of a body comprised of a pump, an actuation mechanism, a nozzle, and a fastener positioned in an interior space of the body;
securing a fishing rod to the fastener;
using the actuation mechanism to active the pump;
removing the fishing rod from the interior space and the fastener; and
placing the fishing rod in an exterior fastener of the body.

20. The method of using a fishing rod and reel cleaning device of claim 19, wherein the actuation mechanism is comprised of a foot pedal.
